(19) United States
(12) Patent Application Publication
(10) Pub. No.: US 2025/0155198 A1
(43) Pub. Date: May 15, 2025

(54) BURN CHAMBER FOR CONDUCTING A BURN TEST OF A CABLE

(71) Applicant: CORNING RESEARCH & DEVELOPMENT CORPORATION, Corning, NY (US)

(72) Inventors: Thomas Meyer, Berlin (DE); Waldemar Stöcklein, Coburg (DE)

(21) Appl. No.: 19/020,120

(22) Filed: Jan. 14, 2025

Related U.S. Application Data
(63) Continuation of application No. PCT/US2023/026290, filed on Jun. 27, 2023.
(60) Provisional application No. 63/389,107, filed on Jul. 14, 2022.

(51) Int. Cl. F27B 17/02; G01N 31/12

(52) U.S. Cl. CPC F27B 17/02; G01N 31/12

(57) ABSTRACT

A burn chamber (1) for conducting a burn test of a cable (2) includes a housing (10) for housing the cable (2) during cable burn testing, a supporting device (20) for supporting the cable (2), and the supporting device (20) being arranged in the burn chamber (1), a burner (30) being configured to produce a flame which is suitable to ignite the cable (2). The supporting device (20) is arranged in the burn chamber (1), and the burner is arranged in the burn chamber (1) at a distance above a bottom of the burn chamber (1). A surface of an inner wall (11) of the housing (10) is configured to have an emissivity in a range between 0.7 and 1.0.

### CROSS-REFERENCE TO RELATED APPLICATIONS

This application is a continuation of International Application No. PCT/US2023/026290, filed Jun. 27, 2023, which claims the benefit of priority of U.S. Provisional Application Ser. No. 63/389,107 filed on Jul. 14, 2022, the content of which is relied upon and incorporated herein by reference in its entirety.

### BACKGROUND

The disclosure relates to a burn chamber for conducting a burn test of a cable, for example a fiber optic cable. Furthermore, the disclosure relates to a method for performing a burn test of a cable, for example a fiber optic cable.

Electrical and optical cables, especially all indoor cables, for the European market, must be certified according to the Construction Product Regulation. This law requires cable certification according to the European Standard CLC EN 50575. The European Standard specifies reaction to fire performance requirements, test and assessment methods for cables used for the supply of electricity and for control and communication purposes, which are intended for use in construction works and subject to performance requirements on reaction to fire. The cables covered by this standard are intended to be used for the supply of electricity and communications in buildings and other civil engineering works with the objective of limiting the generation and spread of fire and smoke. The European Standard CLC EN 50575 covers, inter alia, power cables, control and communication cables, and optical fiber cables for use in, for example, telecommunication, data transmission, radio frequency, video communication and signalling and control equipment. Testing has to be done according to CLC EN 50399, and the final classification is described in CLC EN 13501-6.

In order to conduct a burn test to investigate fire performance of the cable, a burn chamber, for example a Bunched Cable Burn Chamber, is used. The cables to be tested with respect to their fire performance are arranged inside the chamber on a supporting device, for example on ladders, and then ignited with a burner. After a defined testing time, for example 20 minutes, the burner is turned off and the flames are extinguished. Test criteria are the length of the burnt cable as well as the calorimetric data, for example the total heat release, peak heat release rate, the speed of fire propagation/Fire Growth RAte (FIGRA), and smoke production.

The burn results are impacted by many parameters, for example gas supply, dimensions, arrangement of the cables on the supporting device/ladder, airflow inside the chamber, etc. Careful investigations were performed during the standard development and thus most of the parameters were defined, i.e. nominal values plus variations are listed in the standard which describes, for example, the experimental set-up and the procedure to perform the burn test.

Even though it seems that all relevant parameters were taken into account, the experimental results, for example the so-called Flame Spread (FS), show strong variation across the different laboratories.

There is a desire to provide a burn chamber for conducting a burn test of a cable that allows parameters characterizing the fire performance, such as the flame spread, to be measured with low variation over time and high reproducibility.

### SUMMARY

Aspects of the present disclosure include a burn chamber for conducting a burn test of a cable, wherein the burn chamber allows to provide parameters characterizing the fire performance of the cable with high accuracy. An exemplary burn chamber includes a housing for housing the cable during cable burn testing, a supporting device for supporting the cable, and a burner. The supporting device is arranged in the burn chamber. The burner is arranged in the burn chamber at a distance above a bottom of the chamber. The burner is configured to produce a flame which is suitable for igniting the cable. A surface of an inner wall of the housing is configured to have an emissivity ε in the range between 0.7 and 1.0.

In accordance with aspects of the present disclosure, it has been determined that a burn chamber with a very low emissivity, for example an emissivity ε<0.1, of its inner wall reflects most of the thermal radiation, and thus the average temperature at the position of the cables mounted on a supporting device/ladder inside the housing of the chamber will be higher compared to a burn chamber with a high emissivity, for example an emissivity ε>0.7, of its inner wall. As a result, in a burn chamber having an inner wall of low or very low emissivity, the burn process is supported which finally leads to a higher Flame Spread (FS) as compared to a burn chamber having high emissivity.

Since experimental results obtained during the burn test of a cable should not depend on the status of the burn chamber, particularly the status of the emissivity of the inner metallic wall of the chamber, the surface of the inner wall of the housing of the burn chamber should have a fixed value of emissivity during the complete operation life of the burn chamber. For practical reasons, it seems that a value ε of emissivity of the surface of the inner wall of the housing in the range between 0.7 and 1.0, preferably in the range between 0.8 and 1.0, and more preferably in the range between 0.9 and 1.0 seems to be appropriate for conducting a burn test which is almost not influenced by the number of tests already performed by the burn chamber, i.e. the aging of the burn chamber. An emissivity ε=0.95 of the surface of the inner wall of the housing of the burn chamber is believed to represent an almost ideal absorption of radiation similar to a black body (ε=1.0).

According to an embodiment of the burn chamber, the surface of the inner wall of the housing of the burn chamber is configured to have an emissivity ε in the range specified above before the burn chamber is used for the first time to conduct the burn test. In this case, the emissivity of the surface of the inner wall is already so high at the beginning of use of the burn chamber that it can hardly be further increased and thus changed as a result of use, i.e. as a result of deposits on the inner wall resulting from a combustion process.

According to another embodiment, the surface of the inner wall of the housing of the burn chamber is configured to maintain the emissivity in the above-specified range regardless of whether the burn chamber has already been used one or several times, for example one or/to 20 times to carry out the fire test.

According to an embodiment of the burn chamber, the surface of the inner wall of the housing of the burn chamber may be covered with a coating that is configured to provide the surface of the inner wall of the housing with the emissivity ε in the above-specified range. For example, the coating may have a color that is configured to absorb thermal radiation so that the emissivity of the surface of the inner wall of the housing is in the above-specified range.

According to another possible embodiment, the inner wall of the housing may have a roughened surface. The roughened surface is configured to provide the inner wall of the housing of the burn chamber with an emissivity ε in the above-specified range. The inner wall of the housing may be provided with the roughened surface by mechanical or chemical treatment of a material of the inner wall.

According to another possible embodiment of the burn chamber, the surface of the inner wall of the housing of the burn chamber may be covered with a layer of soot. The layer of soot is configured to provide the inner wall with the emissivity ε in the above-specified range. The layer of soot may be generated by burning an appropriate material which produces heavy smoke deposits in the chamber, for example Heptane or a mixture of Toluol and Ethanol.

In accordance with yet other aspects of the present disclosure, a method for performing a burn test of a cable allows parameters to be obtained that specify the fire performance of the cable with high accuracy and low variation over time. According to the method for performing the burn test of the cable, a burn chamber is provided, wherein the burn chamber includes a housing for housing the cable during cable burn testing, a supporting device for supporting the cable, and a burner. The supporting device is arranged in the burn chamber. The burner is arranged in the burn chamber at a distance above a bottom of the burn chamber. The burner is configured to produce a flame which is suitable for igniting the cable. A surface of an inner wall of the housing is treated to have an emissivity ε in the range between 0.7 and 1.0. The cable is disposed on the supporting device. The cable is ignited by the burner to investigate fire characteristics of the cable.

According to a possible embodiment of the method for performing the burn test of the cable, a metallic material of the inner wall of the housing of the burn chamber is covered with a color being configured to absorb thermal radiation, and to provide the inner wall with the emissivity ε in the range between 0.7 and 1.0.

According to another possible embodiment of the method for performing the burn test of the cable, a metallic material of the inner wall of the housing of the burn chamber is covered with a layer of soot. The layer of soot is configured to provide the inner wall with the emissivity ε in the range between 0.7 and 1.0. In order to create a layer of soot on the surface of the inner wall, a material may be burned in the burn chamber, wherein the material creates the soot on the surface of the inner wall.

According to another possible embodiment of the method for performing the burn test of the cable, a metallic material of the inner wall of the housing of the burn chamber is roughened to provide the surface of the inner wall with the emissivity ε in the range between 0.7 and 1.0.

Additional features and advantages of the burn chamber for conducting a burn test of a cable are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWING

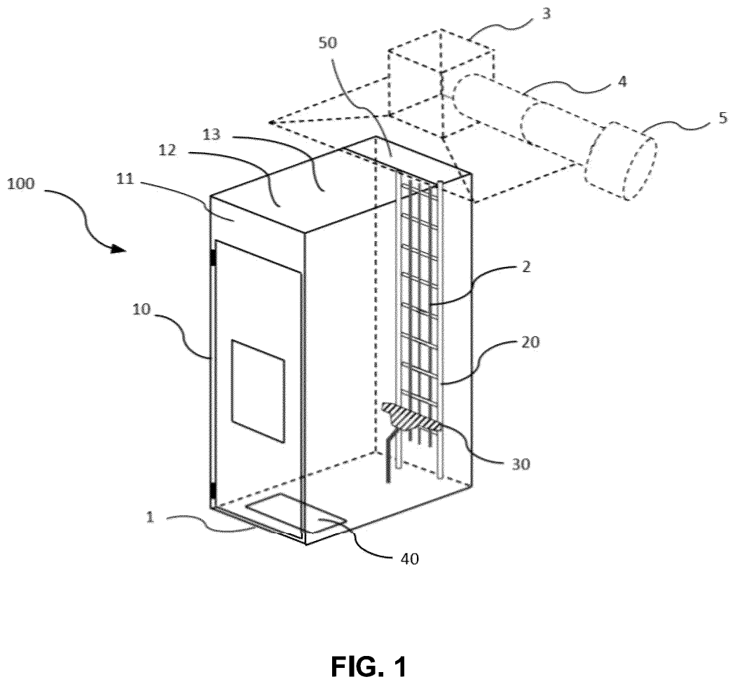

The accompanying drawing is included to provide further understanding, and is incorporated in, and constitutes a part of, the specification. As such, the disclosure will be more fully understood from the following detailed description, taken in conjunction with the accompanying FIG. 1, which shows an embodiment of an arrangement for performing a burn test of a cable comprising a burn chamber including a housing having an inner wall with an emissivity in the range between 0.7 and 1.0.

### DETAILED DESCRIPTION

FIG. 1 shows an arrangement 100 for investigating the fire performance of a cable, for example a fiber optic cable. The arrangement 100 comprises a burn chamber 1 for conducting the burn test of the cable. The burn chamber comprises a housing 10 for housing at least one cable 2 during cable burn testing. The burn chamber further comprises a supporting device 20 which may be configured as a ladder for supporting the at least one cable 2, and which is arranged in the burn chamber 1. The arrangement 100 further comprises a burner 30 being arranged in the burn chamber 1 at a distance above a bottom of the burn chamber. The burner 30 is configured to produce a flame which is suitable for igniting the at least one cable 2.

The burn chamber 1 may include an air supply inlet 40 to supply the inside of the housing 10 with fresh air during the cable burn test. A hood 3, which is not connected to the burn chamber 1, is located at the top of the burn chamber, and connected to exhaust pipe 4. An extraction fan 5 is coupled to the exhaust pipe 4 to exhaust the combustion air from the interior of the burn chamber 1 through a gas outlet 50.

In order to perform a burn test, a cable 2, for example a fiber optic cable, is mounted on the supporting device/ladder 20 and ignited by the burner 30. After a specified burning time, the burner is turned off and the flames are extinguished. The burn chamber 1 may be used to investigate the burnt cable length, calorimetric data, for example total heat release, peak heat release rate, FIGRA (Fire Growth RAte) etc., and smoke production during the burn test.

Experiments were performed in a Bunched Cable Burn Chamber, as illustrated in FIG. 1, on specially developed reference cables. The burn tests were carried out under exactly the same conditions and were recorded over a plurality of years, particularly six years. Surprisingly, the Flame Spread (FS), which is a measure for the flame growth from the end of the cable 2 close to the burner 30 upwards, showed strong variation, and decreased over the years from approximately 2.0 m down to 1.8 m. It was hypothesized that a kind of aging effect was the cause of that observation.

An experiment was set up in which the inner metallic walls 11 of the burn chamber 1 were covered with virgin, shiny metallic plates as they were when the burn chamber was in new, unused condition. Burn tests were performed on the reference cables and the original value of the Flame Spread of 2.0 m could indeed be reproduced. An analysis of the experimental data showed that the emissivity ε of the metal inner walls 11 was the key parameter which was responsible for the deviation of the flame spread over the years. It could further be shown that the shiny plates of the inner wall have a very low emissivity, for example an emissivity ε<0.1, compared to the “aged” soot-covered plates in the chamber after several years of operation. The soot-covered plates of the inner wall after several years of operation of the burn chamber showed a high emissivity, for example an emissivity ε=0.7.

The emissivity ε of a surface of a material is its effectiveness in emitting energy as thermal radiation. Quantitatively, emissivity is the ratio of the thermal radiation from a surface to the radiation from an ideal black surface at the same temperature as given by the Stefan-Boltzmann law. The ratio, i.e. the emissivity ε, varies from 0 to 1.

A burn chamber comprising an inner wall 11 with a low emissivity reflects most of the thermal radiation so that the average temperature at the position of a cable 2 mounted on the supporting device 20 is higher compared to the average temperature of a burning cable which is housed in a burn chamber having an inner wall 11 with high emissivity. In conclusion, a burn process is supported by an inner wall 11 having low emissivity, which finally leads to a higher flame spread. It is believed by the inventors that an inner wall 11 of the housing 10 having an emissivity ε in the range between 0.7 and 1.0 is suitable for emitting so little thermal radiation that the parameters to be investigated and defining the fire performance of a cable, such as the Flame Spread (FS), are not distorted during the years of operation of the burn chamber.

According to a possible embodiment of the burn chamber 1, the inner wall 11 of the housing 50 may be configured to have an emissivity ε in the range between 0.8 and 1.0, preferably in the range between 0.9 and 1.0. For practical reasons it is believed by the inventors that a value of an emissivity ε=0.95 seems to be appropriate since a surface of an inner wall 11 of the housing 10 of the burn chamber 1 having an emissivity ε=0.95 represents an almost ideal absorption of radiation similar to a black body with ε=1.0.

The surface of the inner wall 11 of the housing 10 is configured to have an emissivity ε in the range between 0.7 and 1.0, preferably between 0.8 and 1.0, and more preferably between 0.9 and 1.0 before the burn chamber 1 is used for the first time to conduct the burn test. That means that the inner wall 11, for example a metallic surface of the inner wall 11, is already pre-treated/conditioned to have emissivity in the range between 0.7 and 1.0, preferably between 0.8 and 1.0, and more preferably between 0.9 and 1.0 before the burn chamber 1 is put into operation for performing a cable burn test for the first time. As a result, the emissivity, which is already very high when the burn chamber is started up, therefore does not change noticeably during the service life of the burn chamber. In particular, the already high emissivity does not arise in the course of time, i.e. during fire tests, due to soot deposits on the wall surfaces, for example.

The surface of the inner wall 11 of the housing 10 is rather configured to maintain the emissivity in the range ε between 0.7 and 1.0, preferably between 0.8 and 1.0, and more preferably between 0.9 and 1.0, after the burn chamber 1 has been used one or several times, for example one time or more, to perform the burn test. Moreover, the surface of the inner wall 11 of the housing 10 may be configured to maintain the emissivity in the range between 0.7 and 1.0, preferably between 0.8 and 1.0, and more preferably between 0.9 and 1.0, during conduction of a burn test. This means that the emissivity of the surface of the inner wall 11 is not, or is only imperceptibly, changed by additional deposits on its surface as a result of a combustion process.

In order to provide the surface of the inner wall 11 of the housing 10 with the emissivity in the range between 0.7 and 1.0, preferably between 0.8 and 1.0, and more preferably between 0.9 and 1.0, the surface of the inner wall 11 may be covered with a coating 12. After application of the coating, it has to be ensured by a measurement of the emissivity that the correct value ε of the desired emissivity was achieved.

The coating 12 may have a color being configured to absorb thermal radiation so that the emissivity of the surface of the inner wall 11 of the housing 10 is in the range between 0.7 and 1.0, preferably between 0.8 and 1.0, and more preferably between 0.9 and 1.0. In particular, the coating 12 may be provided by painting the metallic, shiny inner wall 11 of the housing 10 with an appropriate color which absorbs the thermal radiation. A coating available on the market, for example Aremco HiE-Coat®, may be used as an appropriate coating for the inner wall 11 of the housing 10.

According to another possible embodiment, the inner wall 11 of the housing 10 may have a roughened surface that is configured to provide the inner wall 11 with the emissivity ε in the range between 0.7 and 1.0, preferably between 0.8 and 1.0, and more preferably between 0.9 and 1.0. Roughening the surface of the inner wall 11 of the housing 10 can be done mechanically but a chemical treatment is also feasible.

According to another possibility for providing the inner wall 11 of the housing 10 with an emissivity ε in the range between 0.7 and 1.0, preferably between 0.8 and 1.0, and more preferably between 0.9 and 1.0, the inner wall 11 of the housing 10 may be covered with a layer of soot 13.

Covering the wall with the layer of soot 13 can be done by burning a material in the interior of the burn chamber 1, which creates a lot of smoke or soot. An appropriate mixture of liquids to be used to provide the layer of soot 13 may comprise Toluol and Ethanol. Similar to the application of a coating being embodied as a color, the efficiency of the layer of soot 13 to provide the inner wall 11 with the emissivity ε in the above-specified range between has to be checked with the measurement of the emissivity.

The emissivity of the surface of the inner wall 11 of the housing 10 may be measured using known devices, such as Leslie's Cube, in conjunction with a thermal radiation detector such as a thermopile or a bolometer. The apparatus compares the thermal radiation from a surface to be tested with the thermal radiation from a nearly ideal, black sample. The detectors are essentially black absorbers with very sensitive thermometers that record the detector's temperature rise when exposed to thermal radiation.

Furthermore, the emissivity ε of the inner wall 11 of the housing 10 of the burn chamber can be determined by using a thermographic camera. For example, an infrared camera is an instrument used to measure the temperature of an object by using its thermal radiation. The calibration of the camera involves the emissivity of the surface that's being measured. The temperature of the surface of the inner wall 11 of the housing of the burn chamber may be measured, for example, by a calibrated thermocouple. The temperature of the surface is then measured again with the thermographic camera, wherein the emissivity parameter of the camera is changed, until the correct temperature is shown by the camera.

The embodiments of the burn chamber for conducting a burn test of a cable disclosed herein have been discussed for the purpose of familiarizing the reader with novel aspects of the design of the burn chamber. Although preferred embodiments have been shown and described, many changes, modifications, equivalents and substitutions of the disclosed concepts may be made by one having skill in the art without unnecessarily departing from the scope of the claims.

In particular, the design of the burn chamber for conducting a burn test of a cable is not limited to the disclosed embodiments and gives examples of many alternatives as possible for the features included in the embodiments discussed. However, it is intended that any modifications, equivalents, and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element and is not limited to be construed as meaning only one.

What is claimed is:

1. A burn chamber for conducting a burn test of a cable, comprising:
a housing (10) for housing the cable (2) during cable burn testing,
a supporting device (20) for supporting the cable (2), the supporting device (20) being arranged in the burn chamber (1),
a burner (30) being arranged in the burn chamber (1) at a distance above a bottom of the burn chamber (1), the burner (30) being configured to produce a flame which is suitable to ignite the cable (2),
wherein a surface of an inner wall (11) of the housing (10) is configured to have an emissivity in a range between 0.7 and 1.0.

2. The burn chamber of claim 1, wherein the surface of the inner wall (11) of the housing (10) is configured to have the emissivity in the range between 0.7 and 1.0 before the burn chamber (1) is used for the first time to conduct the burn test.

3. The burn chamber of claim 1, wherein the surface of the inner wall (11) of the housing (10) is configured to maintain the emissivity in the range between 0.7 and 1.0 during conducting the burn test.

4. The burn chamber of claim 1, wherein the surface of the inner wall (11) of the housing (10) is configured to maintain the emissivity in the range between 0.7 and 1.0 after the burn chamber (1) has been used one time or more times to perform the burn test.

5. The burn chamber of claim 1, wherein the surface of the inner wall (11) of the housing (10) is covered with a coating (12), the coating (12) being configured to provide the surface of the inner wall (11) of the housing (10) with the emissivity in the range between 0.7 and 1.0.

6. The burn chamber of claim 5, wherein the coating (12) has a color being configured to absorb thermal radiation so that the emissivity of the surface of the inner wall (11) of the housing (10) is in the range between 0.7 and 1.0.

7. The burn chamber of claim 1, wherein the inner wall (11) of the housing (10) has a roughened surface, the roughened surface being configured to provide the inner wall (11) with the emissivity in the range between 0.7 and 1.0.

8. The burn chamber of claim 7, wherein the inner wall (11) of the housing (10) is provided with the roughened surface by mechanical or chemical treatment of a material of the inner wall (11).

9. The burn chamber of claim 1, wherein the surface of the inner wall (11) is covered with a layer of soot (13), the layer of soot (13) being configured to provide the inner wall (11) with the emissivity in the range between 0.7 and 1.0.

10. A method for performing a burn test of a cable, comprising:
providing a burn chamber (1) including:
a housing (10) for housing the cable (2) during cable burn testing,
a supporting device (20) for supporting the cable (2), the supporting device (20) being arranged in the burn chamber (1),
a burner (30) being arranged in the burn chamber (1) at a distance above a bottom of the burn chamber (1), the burner (30) being configured to produce a flame which is suitable to ignite the cable (2),
treating a surface of an inner wall (11) of the housing (10) to have an emissivity in a range between 0.7 and 1.0,
disposing the cable (2) on the supporting device (20), and
igniting the cable (2) by the burner (30) to investigate fire characteristics of the cable (2).

11. The method of claim 10, further comprising:
covering a metallic material of the inner wall (11) with a color being configured to absorb thermal radiation and to provide the inner wall (11) with the emissivity in the range between 0.7 and 1.0.

12. The method of claim 10, further comprising:
covering a metallic material of the inner wall (11) with a layer of soot (13), the layer of soot (13) being configured to provide the inner wall (11) with the emissivity in the range between 0.7 and 1.0.

13. The method of claim 12, further comprising:
burning a material in the burn chamber (1), wherein the material creates the layer of soot (13) on the surface of the inner wall (11).

14. The method of claim 12, wherein the layer of soot (13) is generated by burning a mixture of Toluol and Ethanol in the burn chamber (1).

15. The method of claim 10, further comprising:
roughening a metallic material of the inner wall (11) to provide the surface of the inner wall (11) with the emissivity in the range between 0.7 and 1.0.
